(19) United States
(12) Patent Application Publication
(10) Pub. No.: US 2012/0170251 A1
(43) Pub. Date: Jul. 5, 2012

(54) LIGHTING PENETRATING DEVICE WITH APPEARANCE OF BIONIC TEXTURE

(76) Inventors: Li-Sheng Teng, New Taipei City (TW); Ya-Chi Hsiao, New Taipei City (TW); Hsin-Yi Hsu, New Taipei City (TW); Chien-Chi Chiu, New Taipei City (TW); Chih-Kang Chen, New Taipei City (TW)

(21) Appl. No.: 13/287,128

(22) Filed: Nov. 2, 2011

(30) Foreign Application Priority Data
Dec. 30, 2010 (TW) 099225601

(51) Int. Cl. G09F 13/04; F21V 99/00

(52) U.S. Cl. 362/97.1; 362/362

(57) ABSTRACT

A lighting penetrating device with appearance of bionic texture is disclosed. The lighting penetrating device includes alight source for projecting light, and an appearance structure for covering the light source. The appearance structure is made of bionic material, and a plurality of bionic textures is formed on the appearance structure. The light projected from the light source can penetrate through the appearance structure.

### BACKGROUND OF THE INVENTION

1. Field of the Invention

The present invention relates to a lighting penetrating device, and more particularly, to a lighting penetrating device with appearance of bionic texture.

2. Description of the Prior Art

With growing demands on product quality of modern consumers, products capable of promoting emotional feelings has gradually become one of the key factors when designers develop the products. In order to use the products effectively, consumers think a commodity not only to be equipped with basic performance, comfortable ergonomics and good user interface, but also to be equipped with aesthetic feeling and emotion taken into consideration. However, current consumer electronics and household appliances, such as lighting devices, often bring the consumers distant feeling of the brand impression. In the modern consumer market, people with different demands on products from those in the past request good performance as well as pure and fresh feeling for the products. As a result, how to combine life characteristics with the appearance design of current consumer electronics for making the design return to nature, so as to create the consumer electronics with good performances, light structures, suitable materials and aesthetic feelings of design, becomes the important issue in product design field.

### SUMMARY OF THE INVENTION

The present invention provides a lighting penetrating device with appearance of bionic texture for solving above drawbacks.

According to the claimed invention, a lighting penetrating device includes a light source for projecting light and an appearance structure for covering the light source. The appearance structure is made of bionic material, and a plurality of bionic textures is formed on the appearance structure for penetrating the light projected from the light source.

According to the claimed invention, at least one groove is formed on a side facing the light source of the appearance structure for penetrating the light projected from the light source.

According to the claimed invention, the groove is formed on the side facing the light source of the appearance structure in a machining manner or in a thermoforming manner, so as to control penetration of the light projected from the light source by adjusting a depth of the groove.

According to the claimed invention, a thickness corresponding to the groove of the appearance structure is substantially smaller than 0.5 mm.

According to the claimed invention, a thickness corresponding to the groove of the appearance structure is substantially between 1 mm and 0.5 mm.

According to the claimed invention, the appearance structure is made of thermoplastic elastomer material.

According to the claimed invention, the appearance structure is made by foaming process.

According to the claimed invention, the appearance structure is a decorating plate or a frame.

According to the claimed invention, the lighting penetrating device is a display device.

The lighting penetrating device utilizes the appearance structure of bionic texture to show natural aesthetic feeling of penetration of the light. As a result, life characteristics can be merged into the appearance design of current consumer electronics for making the design return to nature. Accordingly, the consumer electronics with good performances, light structures, suitable materials and aesthetic feelings of design can be achieved.

These and other objectives of the present invention will no doubt become obvious to those of ordinary skill in the art after reading the following detailed description of the embodiment that is illustrated in the various figures and drawings.

### BRIEF DESCRIPTION OF THE DRAWINGS

FIG. 1 and FIG. 2 are respectively a schematic diagram and a partially exploded diagram of a lighting penetrating device with appearance of bionic texture according to an embodiment of the present invention.

FIG. 3 is an internal structure diagram of the lighting penetrating device according to the embodiment of the present invention.

FIG. 4 and FIG. 5 are respectively diagrams of a groove formed on an inner side of an appearance structure according to different embodiments of the present invention.

FIG. 6 and FIG. 7 are respectively schematic diagrams of the lighting penetrating device in different views according to another embodiment of the present invention.

### DETAILED DESCRIPTION

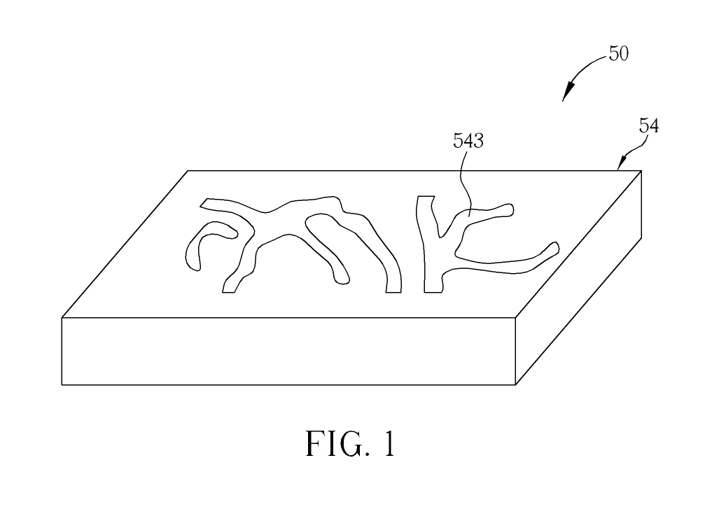

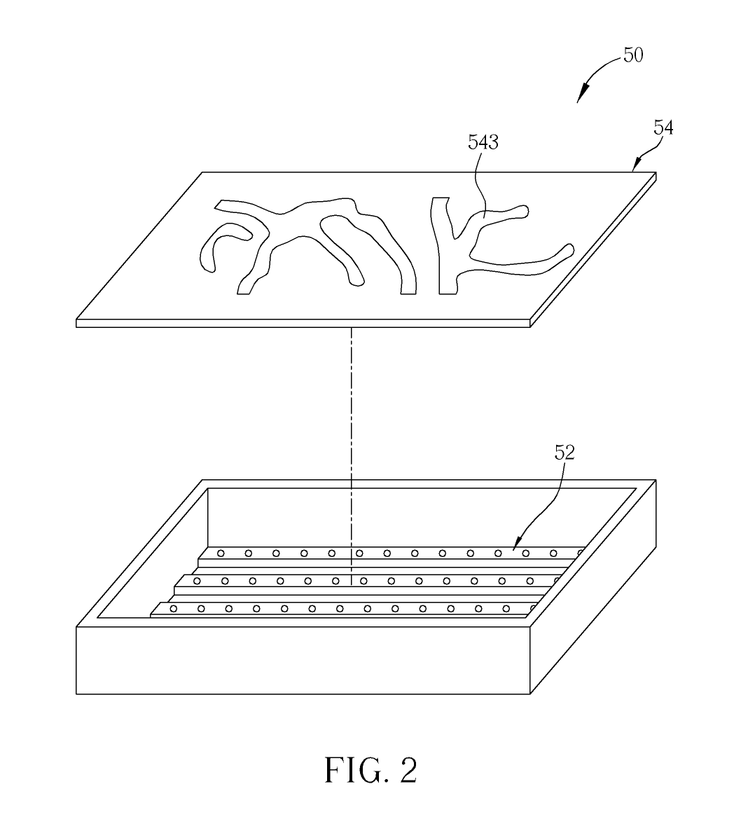

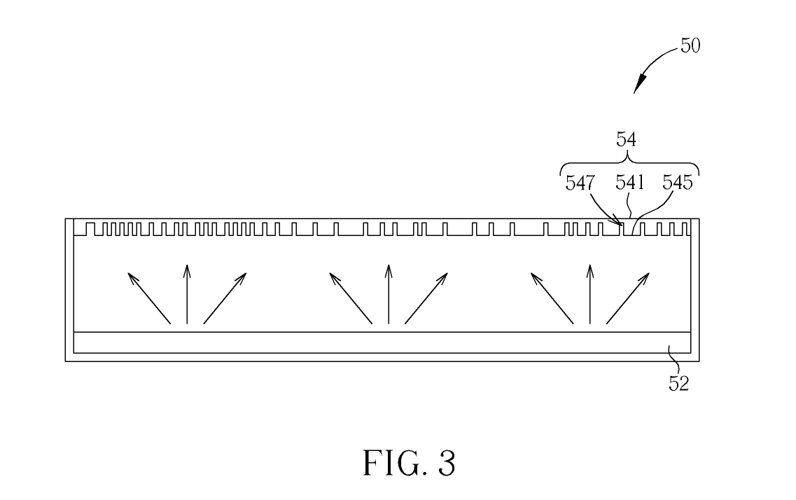

Please refer to FIG. 1 and FIG. 2. FIG. 1 and FIG. 2 are respectively a schematic diagram and a partially exploded diagram of a lighting penetrating device 50 with appearance of bionic texture according to an embodiment of the present invention. In this embodiment, the lighting penetrating device 50 can be a lighting device such as a lamp with decoration, and so on. The lighting penetrating device 50 includes a light source 52 for projecting light. The light source 52 can be various light emitting components such as a LED strip, a bulb, a backlight module, and so on. The lighting penetrating device 50 further includes an appearance structure 54 for covering the light source 52. The appearance structure 54 is made of bionic material. For example, the appearance structure 54 can be made of thermoplastic elastomer (TPE) material, such as styrene-butadiene copolymer. The thermoplastic elastomer material has advantages of high elasticity, high strength, high rebound resilience and capability of being manufactured by teeming-molding process. Besides, it also has advantages of poison free, large range of hardness, easy dyeing, good touching feeling, durability, superior fatigue resistance, waterproof, fire retardancy, good performance of machining, vulcanization-less and translucence, and what matters is that waste material during manufacturing process and no-good piece of thermoplastic elastomer product can be recycled directly. Further, used thermoplastic elastomer products can be recycled after simple regenerating process, so as to reduce environmental pollution. Accordingly, it belongs to recycling material. Moreover, the thermoplastic elastomer material can be made without vulcanized process or with short vulcanized time, so as to save energy. In summary, the appearance structure 54 made of thermoplastic elastomer material is a new-typed material for energy conservation and environment protection, and it is applied for consumer electronics so as to meet all environmental protection regulations. In addition, the appearance structure 54 can be made by foaming process. There are pores on the surface so that appearance of bionic texture such as wood, marble, ceramics and so on can be achieved by printing or dyeing materials with bionic color. Please refer to FIG. 1 to FIG. 3. FIG. 3 is an internal structure diagram of the lighting penetrating device 50 according to the embodiment of the present invention. A plurality of bionic textures 543 can be formed on an outer side 541 of the appearance structure 54. For example, the bionic textures 543 can be wooden textures, marble textures and so on. It depends on practical demands. In such a manner, the lighting penetrating device 50 can emphasize the spirits of harmony on human, machine and nature of product.

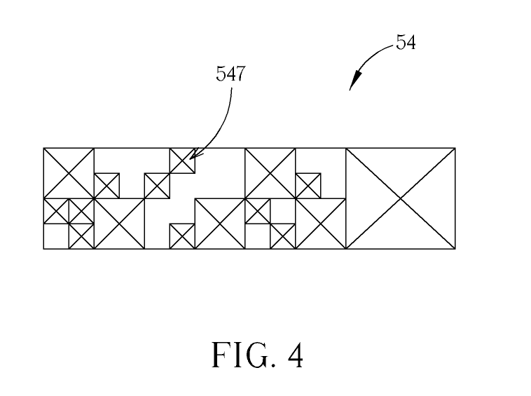

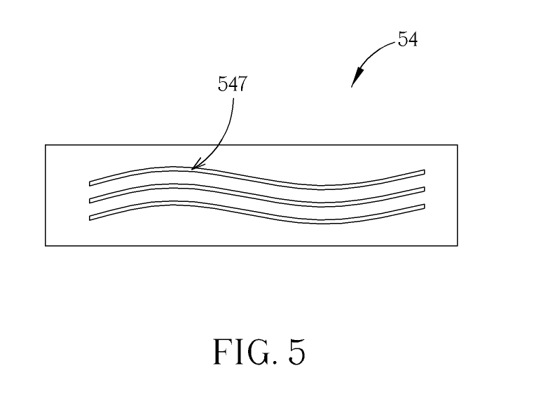

Furthermore, at least one groove 547 is formed on an inner side 545 facing the light source 52 of the appearance structure 54 for penetrating the light projected from the light source 52. The groove 547 can be formed on the inner side 545 facing the light source 52 of the appearance structure 54 in a machining manner or in a thermoforming manner. For example, the groove 547 can be formed on the inner side 545 facing the light source 52 of the appearance structure 54 in the machining manner during pilot run, and the groove 547 can be formed on the inner side 545 facing the light source 52 of the appearance structure 54 in the thermoforming manner in mass production. It can control penetration of the light projected from the light source 52 by adjusting a depth of the groove 547. Please refer to FIG. 3 to FIG. 5. FIG. 4 and FIG. 5 are respectively diagrams of the groove 547 formed on the inner side 545 of the appearance structure 54 according to different embodiments of the present invention. The shape and depth of the groove 547 can determine the feeling of penetration of the light projected from the light source 52. For example, as the groove 547 is formed in a grid shape as shown in FIG. 4, the penetrating light reveals in the rectangular grid shape. As the groove 547 is formed in a strip shape as shown in FIG. 5, the penetrating light reveals in the strip shape. As for the depth of the groove 547, for example, when a thickness D corresponding to the groove 547 of the appearance structure 54 is smaller than 1 mm, the groove 547 can be capable of light penetration. Furthermore, when the thickness D corresponding to the groove 547 of the appearance structure 54 is substantially smaller than 0.5 mm, the groove 547 can be optimally capable of light penetration. On the other hand, the thickness D corresponding to the groove 547 of the appearance structure 54 can be substantially between 1 mm and 0.5 mm, so as to generate corresponding light penetrating effect. In other words, penetration of the light can be controlled by different depths of the groove 547, so as to appear different aesthetic feelings.

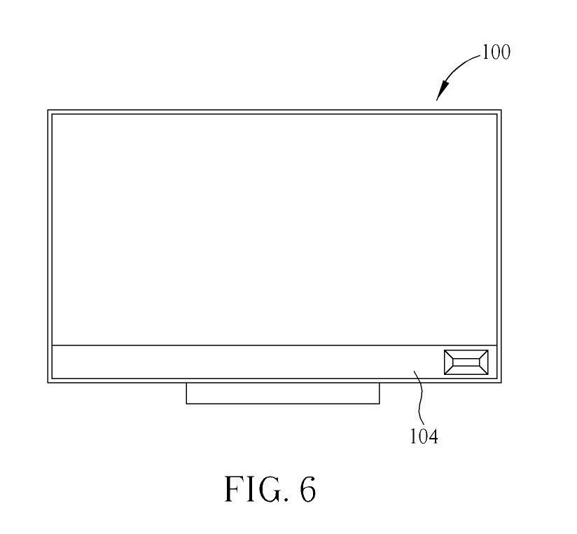

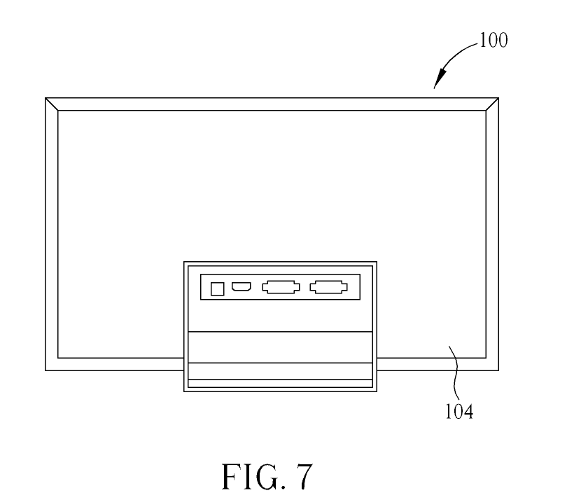

Please refer to FIG. 6 and FIG. 7. FIG. 6 and FIG. 7 are respectively schematic diagrams of the lighting penetrating device 100 in different views according to another embodiment of the present invention. In this embodiment, the lighting penetrating device 100 can be a display device, an all-in-one PC and so on. The lighting penetrating device 100 also includes an appearance structure 104. The appearance structure 104 can be a decorating plate, a frame and so on. If the appearance structure 104 is made of bionic material with wooden texture, the lighting penetrating device 100 can appear sense of wooden shape. The disposal and amount of the appearance structure 104 are not limited to those mentioned in this embodiment, and it depends on practical demands. In addition, the lighting penetrating device of the present invention can be applied for various consumer electronics, such as 3C electronic products, household appliances and so on. The appearance structure with bionic texture can be in different types of structures and materials. As for structures, the appearance structure can be in type of a housing of television, a back cover of a cell phone, a back cover of a computer and so on. As for materials, the appearance structure can be in type of wood, marble, ceramics and so on. It depends on spirits of products.

Compared with the prior art, the lighting penetrating device utilizes the appearance structure of bionic texture to show natural aesthetic feeling of penetration of the light. As a result, life characteristics can be merged into the appearance design of current consumer electronics for making the design return to nature. Accordingly, the consumer electronics with good performances, light structures, suitable materials and aesthetic feelings of design can be achieved.

Those skilled in the art will readily observe that numerous modifications and alterations of the device and method may be made while retaining the teachings of the invention.

What is claimed is:

1. A lighting penetrating device comprising:
a light source for projecting light; and
an appearance structure for covering the light source, the appearance structure being made of bionic material, and a plurality of bionic textures being formed on the appearance structure for penetrating the light projected from the light source.

2. The lighting penetrating device of claim 1, wherein at least one groove is formed on a side facing the light source of the appearance structure for penetrating the light projected from the light source.

3. The lighting penetrating device of claim 1, wherein the groove is formed on the side facing the light source of the appearance structure in a machining manner or in a thermoforming manner, so as to control penetration of the light projected from the light source by adjusting a depth of the groove.

4. The lighting penetrating device of claim 3, wherein a thickness corresponding to the groove of the appearance structure is substantially smaller than 0.5 mm.

5. The lighting penetrating device of claim 3, wherein a thickness corresponding to the groove of the appearance structure is substantially between 1 mm and 0.5 mm.

6. The lighting penetrating device of claim 1, wherein the appearance structure is made of thermoplastic elastomer material.

7. The lighting penetrating device of claim 1, wherein the appearance structure is made by foaming process.

8. The lighting penetrating device of claim 1, wherein the appearance structure is a decorating plate or a frame.

9. The lighting penetrating device of claim 8, being a display device.
